(19) United States
(12) Patent Application Publication
(10) Pub. No.: US 2024/0253263 A1
(43) Pub. Date: Aug. 1, 2024

(54) BAMBOO OUTER SKIN-RETAINING BAMBOO VENEER AND PREPARATION PROCESS THEREOF

(71) Applicant: Long Bamboo Technology Group Co., Ltd., Nanping (CN)

(72) Inventors: Jianchang LIAN, Nanping (CN); Xuecai YE, Nanping (CN)

(73) Assignee: Long Bamboo Technology Group Co., Ltd., Nanping (CN)

(21) Appl. No.: 18/635,182

(22) Filed: Apr. 15, 2024

Related U.S. Application Data
(63) Continuation of application No. PCT/CN2022/127989, filed on Oct. 27, 2022.

(30) Foreign Application Priority Data
Nov. 16, 2021 (CN) 202111355837.4
Nov. 16, 2021 (CN) 202111357117.1

(51) Int. Cl. B27J 1/00; B27K 5/00; B27K 5/06; B27K 9/00

(52) U.S. Cl. CPC B27J 1/00; B27K 5/0085; B27K 5/06; B27K 9/002

(57) ABSTRACT

Disclosed are a bamboo outer skin-retaining bamboo veneer and a preparation process thereof, belonging to the technical field of bamboo processing. The preparation process includes the following steps: segmenting bamboo and cutting into bamboo strips with an arc-shaped section; softening the bamboo strips by pressurizing and heating, and unfolding the softened bamboo strips at equal arc and fixed thickness; performing double-sided protection and gradual flattening under a condition of heat preservation until the bamboo strip is completely flattened, to obtain a bamboo board; and continuously cooling the bamboo board, shaping the bamboo board under a heavy weight and then drying, and then trimming under a fixed width to obtain the bamboo outer skin-retaining bamboo board finished product. The bamboo outer skin-retaining bamboo strip can be unfolded under the promise of not destroying the bamboo outer skin surface, and there will be no cracking and rebound problems.

### CROSS-REFERENCE TO RELATED APPLICATIONS

This application is a continuation of International Application No. PCT/CN2022/127989, filed on Oct. 27, 2022, which claims priority to Chinese Patent Application No. 202111355837.4, filed on Nov. 16, 2021, and Chinese Patent Application No. 202111357117.1, filed on Nov. 16, 2021. All of the aforementioned applications are incorporated herein by reference in their entireties.

### TECHNICAL FIELD

The present invention belongs to the technical field of bamboo processing, and more particularly, relates to a bamboo outer skin-retaining bamboo veneer and a preparation process thereof.

### BACKGROUND

Bamboo has become an important alternative raw material to wood in many industries due to its characteristics of faster growth speed and greater regenerative capacity. The implementation of “bamboo instead of wood” in some industries can effectively alleviate the contradiction between supply and demand for wood in China. It is estimated that the use of 1 ton of bamboo will reduce deforestation by 3.9 mu and reduce carbon dioxide emissions by 1.62 tons, so the use of bamboo instead of wood can also effectively alleviate carbon emissions and improve the greenhouse effect.

Bamboo grows naturally in a cylindrical shape, section by section, but most bamboo products, such as furniture, building materials, and daily necessities, need to be prepared using flat boards or sheets. Therefore, bamboo needs to be flattened after cutting. In order to avoid cracking in the flattening process, the steps of removing bamboo joints, bamboo inner skin and bamboo outer skin, opening holes and slots (scribing lines) and other steps are needed first before flattening. For example, the Chinese Invention Patent Publication No. CN113370332B discloses a whole-bamboo unfolding process, which is used to unfold the whole bamboo to obtain a flat bamboo board by removing bamboo outer skin and bamboo inner skin. Another example is the Chinese Invention Patent Publication No. CN105235030B, which discloses a whole-bamboo flattening method, in which a bamboo tube is installed on bamboo processing equipment, outer bamboo joints and inner bamboo joints are removed, bamboo outer skin is removed by a thickness of 2 to 3 mm, and then a slot is formed in the bamboo tube; and the bamboo tube is softened, flattened and cold-pressed to obtain a bamboo board, bamboo inner skin on the inner surface of the bamboo board is removed by 3 to 5 mm, followed by grinding and baking, thereby obtaining the whole bamboo. The bamboo outer skin removed in the processing process has high fiber density, hardness and strength. If the bamboo outer skin can be applied without planning, the waste of bamboo can be effectively reduced, and green-faced bamboo products that are lack in the market can be obtained. At present, there are also processes that can retain a bamboo outer skin surface for flattening, such as the Chinese Invention Patent Application Publication No. CN112873456A, which discloses a bamboo outer skin-retaining flattening process and method, used for obtaining a bamboo outer skin-retaining bamboo strip by scribing lines on bamboo outer skin and cutting bamboo inner skin. However, such processes still require scribing lines on the bamboo outer skin surfaces, which affects the integrity and aesthetics of the products, and the scribed bamboo outer skin surfaces are not suitable for use as appearance surfaces.

### SUMMARY

In order to overcome the above-mentioned defects of the prior art, the technical problem to be solved by the present invention is how to provide a bamboo outer skin-retaining bamboo veneer with bamboo outer skin and without damages such as slotting (scribing) on a bamboo outer skin surface, and a preparation process thereof.

In order to solve the above technical problem, the present invention adopts the following technical solution. A preparation process of a bamboo outer skin-retaining bamboo veneer includes the following steps:
step 1: segmenting bamboo to obtain bamboo tubes, and cutting each bamboo tube into bamboo strips with an arc-shaped section;
step 2: softening the bamboo strips by pressurizing and heating, unfolding the softened bamboo strips at equal arc and fixed thickness, and then shaving bamboo inner skin off,
step 3: performing double-sided protection and gradual flattening on the bamboo strip treated in step 2 under a condition of heat preservation until the bamboo strip is completely flattened, to obtain a bamboo board; and
step 4: continuously cooling the bamboo board, shaping the bamboo board under a heavy weight and then drying until the moisture content is 6 to 10%, and then trimming under a fixed width to obtain the bamboo outer skin-retaining bamboo veneer.

Another technical solution adopted by the present invention is a bamboo outer skin-retaining bamboo veneer which is prepared by the preparation process of the bamboo outer skin-retaining bamboo veneer.

The present invention has the following beneficial effects. According to the preparation process of the bamboo outer skin-retaining bamboo veneer provided by the present invention, the bamboo outer skin-retaining bamboo board can be unfolded under the premise of not opening slots (scribing lines), nailing holes, shaving the bamboo outer skin off and other operations that destroy the bamboo outer skin surface. In the unfolding process, there will be no cracking and rebounding problems. The obtained bamboo outer skin-retaining bamboo veneer has stable performances and high strength. The bamboo outer skin surface of the bamboo outer skin-retaining bamboo veneer is smooth and flat without damages, and has natural and beautiful textures. The bamboo outer skin-retaining bamboo veneer is more suitable for some applications in downstream fields with high requirements for hardness, and fills the gap of the lack of natural green bamboo texture materials in the bamboo market, and can be either used as a board alone, or used as a composite board compounded with other boards, and or used as a raw material of other bamboo products.

Compared with traditional softening by heating, softening by pressurizing and heating in the unfolding process reflects the increase in vapor pressure and temperature increase, which can significantly shorten the softening time, improve the efficiency, and promote a softening effect at the same time, so as to avoid the problem of cracking in the subsequent unfolding process. The unfolding treatment at equal arc length and fixed length ensures the uniformity of the bamboo strips in thickness, provides a basis for the subsequent double-side protection and gradual flattening and avoids the problem of uneven stress caused by uneven thickness. The double-side protection and gradual flattening performed under the condition of heat preservation can effectively avoid the problems of rebound and cracking. Due to the large stress of the bamboo outer skin-retaining bamboo board, continuous cooling can avoid cracking caused by sudden cooling, and the cooled bamboo outer skin-retaining bamboo board is dried under the condition of heavy weights, which ensures the uniformity of the moisture content at different positions of the bamboo outer skin-retaining bamboo board, so that the dried flattened board has no bending, no deformation, and no rebound.

### DETAILED DESCRIPTION OF THE EMBODIMENTS

In order to describe the technical content, implementing objects and effects of the present invention in detail, the following description is given with reference to the embodiments.

The most critical idea of the present invention is to prepare a bamboo outer skin-retaining bamboo veneer using a bamboo outer skin part of bamboo through the optimization of a flattening process, under the premise of not destroying a bamboo outer skin surface.

The present invention provides a preparation process of a bamboo outer skin-retaining bamboo veneer, which includes the following steps:
step 1: segmenting bamboo to obtain bamboo tubes, and cutting each bamboo tube into bamboo strips with an arc-shaped section;
step 2: softening the bamboo strips by pressurizing and heating, unfolding the softened bamboo strips at equal arc and fixed thickness, and then shaving bamboo inner skin off,
step 3: performing double-sided protection and gradual flattening on the bamboo strip, which is unfolded at equal arc and fixed thickness and from which the bamboo inner skin is shaved off in step 2, under a condition of heat preservation until the bamboo strip are completely flattened, to obtain a bamboo board; and
step 4: continuously cooling the bamboo board, shaping the bamboo board under a heavy weight and then drying until the moisture content is 6 to 10%, and then trimming under a fixed width to obtain the bamboo outer skin-retaining bamboo veneer.

Meanwhile, the present invention provides a bamboo outer skin-retaining bamboo veneer which is prepared by the above preparation process. The bamboo outer skin-retaining bamboo veneer can be either used as a board alone, or used as a composite board compounded with other boards, and or used as a raw material of other bamboo products.

From the above description, it can be seen that the beneficial effect of the present invention is that: the proposal of the preparation process of the bamboo outer skin-retaining bamboo veneer of the present invention has further broadened the application scope and field of bamboo. According to the preparation process, the bamboo strips (bamboo boards) can be flattened under the premise of not destroying a bamboo outer skin surface of bamboo, and the flattened bamboo strips have no cracking and no rebound. It is unnecessary to open an oblique slot or nail hole, and also treat bamboo joints in the unfolding process, such that the treatment steps are reduced, and the investment cost is effectively saved. In the unfolding process, softening and unfolding at equal arc and fixed thickness can effectively reduce the problem of cracking in the processing process, but will stretch an inner layer of the bamboo outer skin-retaining bamboo strip and extrude an outer layer (especially, a bamboo outer skin-retaining part) of the bamboo outer skin-retaining bamboo strip, resulting in great internal stress, which will lead to the phenomenon of rebound (bounce) in the subsequent processing. In the present invention, the subsequent protection and gradual flattening under the condition of heat preservation in combination with drying under a heavy weight can effectively balance the problem of internal stress in the above steps, avoid the problem of rebound during the processing and after the processing of the finished product, and makes the steps linked and cooperated with each other, thereby ensuring the smooth unfolding of the bamboo outer skin-retaining bamboo board, avoiding the problem of waste of raw materials and increased processing cost caused by cracking, rebound and other problems. The obtained bamboo outer skin-retaining bamboo veneer can be used directly due to no damages on the surface. Because the bamboo outer skin is retained, the bamboo outer skin-retaining bamboo veneer has good mechanical properties, and is thus more suitable for some applications in downstream fields with high requirements for hardness.

It should be noted that the so-called “opening slots”, “opening linear slots”, “opening oblique slots” and “scribing lines”, etc. in this field all refer to the cutting operations at a certain depth on the surface of bamboo.

Further, in the step 1, the bamboo tube has a diameter of 60 to 150 mm, and the number of bamboo strips cut from the bamboo tube is 3 to 6.

As can be seen from the above description the whole bamboo tube cannot be opened directly, and it needs to be cut into strips first before subsequent flattening treatment.

Further, the conditions of softening by heating in the step 2 are as follows: a pressure is 0.8 to 1.3 MPa, a temperature is 160 to 200° C., and time is 3 to 10 min.

As can be seen from the above description, compared with traditional softening by heating, the vapor pressure and temperature increase, which can significantly shorten the softening time, improve the efficiency, and promote a softening effect at the same time, so as to avoid the problem of cracking in the subsequent unfolding process. However, higher pressures and temperatures do not lead to better results and will increase energy consumption.

Further, the unfolding process at equal arc and fixed thickness in the step 2 is as follows: the softened bamboo strip is pressed into an equal arc shape using an arc roller, and then processed in equal thickness with an arc cutter.

As can be from the above description, the equal-thickness processing can ensure that both sides of the bamboo board can be in complete contact with the equipment during the subsequent double-sided protection and gradual flattening process, so as to avoid the problem of cracking caused by uneven stress.

Further, the unfolding process at equal arc and fixed thickness is as follows: the softened bamboo strip is pressed into an equal arc shape using an arc roller, and then processed in equal thickness with an arc cutter. Equal thickness means that the thickness is equal everywhere.

Further, the condition of heat preservation in the step 3 is 80 to 100° C. The double-side protection and gradual flattening refers to gradually flatten through a plurality of pressing devices. Each pressing device includes an upper pressing plate and a lower pressing plate between which a gap is formed, and radians of the gaps of the plurality of pressing devices are sequentially reduced.

Further, the double-side protection and gradual flattening refers to gradually flatten through a plurality of pressing devices. Each pressing device includes an upper pressing plate and a lower pressing plate between which a gap is formed, and radians of the gaps of the plurality of pressing devices are sequentially reduced.

As can be seen from the above description the heat preservation treatment in the double-side protection and gradual unfolding process is the key, and if it is performed at room temperature or at a higher temperature, cracking will occur in the process of double-sided protection and gradual unfolding.

Further, the continuous cooling in the step 4 is from 100° C. to 25° C. A cooling rate is 10 to 30° C./h. Preferably, a cooling rate is 25° C./h.

As can be seen from the above description that, different from previous bamboo boards from which bamboo outer skin and bamboo inner skin are removed or which are opened with oblique slots and nail holes, the bamboo outer skin-retaining bamboo board needs to be gradually cooled within a certain temperature range to effectively avoid the problem of cracking, because the bamboo outer skin-retaining bamboo board will be cracked if it is directly cooled, i.e., directly cooled in a room temperature environment. Cooling at the above cooling rate range will not cause cracking, but the impact on the mechanical properties of the finished product is negligible.

Further, the conditions of shaping under a heavy weight and drying in the step 4 are as follows: the heavy weight is 1000 to 1200 kg, and a drying temperature is 30 to 60° C.

As can be seen from the above description, shaping under the heavy weight and drying are to press with a heavy weight on one side of the bamboo board, where the pressure can ensure that the moisture content of all parts of the bamboo board is uniform, and can effectively eliminate the internal stress generated in the process of softening and unfolding at variable arc and fixed thickness and achieve an effect of no rebound after drying; and in the drying process, in order to shorten the drying time and improve the efficiency, the drying temperature cannot be increased blindly, because too high drying temperature will lead to the rebound problem after some dried bamboo outer skin-retaining bamboo boards are placed for a period of time.

A bamboo outer skin-retaining bamboo veneer is further provided, which has a density of 0.9 to 1.1 g/cm³, a tensile strength of 296.72 to 311.56 MPa, a flexural strength of 143.14 to 149.65 MPa, a parallel-to-grain tensile strength of 177.76 to 185.84 MPa, a parallel-to-grain compressive strength of 77.70 to 81.22 MPa, a flexural elastic modulus of 10.12 to 11.67 GPa, a fiber content of 56.10 to 60.65%, and a moisture content of 8 to 10%.

A preparation process of the bamboo outer skin-retaining bamboo veneer includes the following steps:
step 1: segmenting bamboo (5-year-old Phyllostachys pubescens or moso bamboo) to obtain bamboo tubes, and cutting each bamboo tube into bamboo strips with an arc-shaped section, where the bamboo tube has a diameter of 60 to 150 mm, and the number of bamboo strips cut from the bamboo tube is 3 to 6;
step 2: softening the bamboo strips by pressurizing and heating, unfolding the softened bamboo strips at equal arc and fixed thickness, and then shaving bamboo inner skin off, where the conditions of softening by pressurizing and heating are as follows: a pressure is 0.8 to 1.3 MPa, a temperature is 160 to 200° C., and time is 3 to 10 min; the unfolding process at equal arc and fixed thickness is as follows: the softened bamboo strip is pressed into an equal arc shape using an arc roller, and then processed in equal thickness with an arc cutter;
step 3: performing double-sided protection and gradual flattening on the bamboo strip treated in step 2 under a condition of heat preservation at 100° C. until the bamboo strip is completely flattened, to obtain a bamboo board, where the double-side protection and gradual flattening refers to gradually flatten through a plurality of pressing devices, each pressing device includes an upper pressing plate and a lower pressing plate between which a gap is formed, and radians of the gaps of the plurality of pressing devices are sequentially reduced; and
step 4: continuously cooling (from 100° C. to 25° C.) the bamboo board, shaping the bamboo board under a heavy weight (the heavy weight is 1200 kg and a drying temperature 40° C.) and then drying until the moisture content is 8 to 10%, and then trimming and shaving under a fixed width to obtain the bamboo outer skin-retaining bamboo veneer with a thickness of 1 to 3 mm.

As can be seen from the above description, as bamboo grows, the bamboo outer skin-retaining bamboo veneer with the above mechanical properties cannot be prepared if the age of the bamboo outer skin part is too young or too old.

The bamboo outer skin-retaining bamboo veneer is made of a part of an outer surface of a bamboo wall that extends radially along the bamboo tube.

As can be seen from the above description, the fiber content will affect the mechanical properties. The fiber content of the bamboo outer skin-retaining bamboo veneer with the above-mentioned mechanical properties provided by the present invention is 56.10 to 60.65%. The moisture content of the finished product will affect the mechanical properties, and the above parameters of the bamboo outer skin-retaining bamboo veneer are within in the range of the moisture content of 8 to 10%. Bamboo from inside to outside is bamboo inner skin, bamboo flesh and bamboo outer skin, where the bamboo inner skin and the bamboo flesh may sometimes be collectively referred to as bamboo inner skin. If the outermost bamboo outer skin and innermost bamboo inner skin parts are not removed in the bamboo processing process, it is very likely to cause cracking during the flattening process, so a large number of bamboo outer skin and bamboo inner skin parts are wasted. The bamboo outer skin-retaining bamboo veneer is made of a part of the outer surface of the bamboo wall that extends radially along the bamboo tube, so the bamboo outer skin part, which is usually used as waste, is reused.

The tests of moisture content, density, parallel-to-grain tensile strength, parallel-to-grain compressive strength, flexural elastic modulus and flexural strength refer to the standard GB/T 17657-2013 “Test Methods for Physical and Chemical Properties of Wood-based Panels and Veneered Wood-based Panels”.

The bamboo outer skin-retaining bamboo veneer of the present invention can be sold as a finished product, and can also be used after being compounded with other boards, e.g., prepared into bamboo flooring and bamboo decorative boards, or can also be prepared into other commodities as raw materials, such as bamboo hangers.

A bamboo board is further provided which includes the above bamboo outer skin-retaining bamboo veneer and has a thickness of 5 to 10 mm. The bamboo board may be thicker according to use demands, which may be compounded by one or more layers of existing bamboo veneers (bamboo veneers obtained by technologies of removing bamboo outer skin and bamboo inner skin) and the bamboo outer skin-retaining bamboo veneer.

### Example 1

An unfolding process of a bamboo outer skin-retaining bamboo strip includes the following steps:
step 1: segmenting bamboo to obtain bamboo tubes, and cutting each bamboo tube into bamboo strips with an arc-shaped section; where the bamboo tube has a diameter of 60 to 90 mm, and the number of bamboo strips cut from the bamboo tube is 3;
step 2: softening the bamboo strips by pressurizing and heating, unfolding the softened bamboo strips at equal arc and fixed thickness, and then shaving bamboo inner skin off, where the conditions of softening by pressurizing and heating are as follows: a pressure is 1.2 MPa, a temperature is 200° C., and time is 3 min; the unfolding process at equal arc and fixed thickness is as follows: the softened bamboo strip is pressed into an equal arc shape using an arc roller, and then processed in equal thickness with an arc cutter;
step 3: performing double-sided protection and gradual flattening on the bamboo strip treated in step 2 under a condition of heat preservation at 100° C. until the bamboo strip is completely flattened, to obtain a bamboo board, where the double-side protection and gradual flattening refers to gradually flatten through a plurality of pressing devices, each pressing device includes an upper pressing plate and a lower pressing plate between which a gap is formed, and radians of the gaps of the plurality of pressing devices are sequentially reduced; and
step 4: continuously cooling the bamboo board, shaping the bamboo board under a heavy weight and then drying until the moisture content is 6 to 10%, and then trimming under a fixed width to obtain the bamboo outer skin-retaining bamboo board finished product.

The continuous cooling is from 100° C. to 25° C., and a cooling rate is 25° C./h; and the conditions of shaping under a heavy weight and drying are as follows: the heavy weight is 1200 kg, and a drying temperature is 40° C.

### Example 2

An unfolding process of a bamboo outer skin-retaining bamboo strip includes the following steps:
step 1: segmenting bamboo to obtain bamboo tubes, and cutting each bamboo tube into bamboo strips with an arc-shaped section; where the bamboo tube has a diameter of 90 to 120 mm, and the number of bamboo strips cut from the bamboo tube is 4;
step 2: softening the bamboo strips by pressurizing and heating, unfolding the softened bamboo strips at equal arc and fixed thickness, and then shaving bamboo inner skin off, where the conditions of softening by pressurizing and heating are as follows: a pressure is 0.8 MPa, a temperature is 180° C., and time is 10 min; the unfolding process at equal arc and fixed thickness is as follows: the softened bamboo strip is pressed into an equal arc shape using an arc roller, and then processed in equal thickness with an arc cutter;
step 3: performing double-sided protection and gradual flattening on the bamboo strip treated in step 2 under a condition of heat preservation at 90° C. until the bamboo strip is completely flattened, to obtain a bamboo board, where the double-side protection and gradual flattening refers to gradually flatten through a plurality of pressing devices, each pressing device includes an upper pressing plate and a lower pressing plate between which a gap is formed, and radians of the gaps of the plurality of pressing devices are sequentially reduced; and
step 4: continuously cooling the bamboo board, shaping the bamboo board under a heavy weight and then drying until the moisture content is 6 to 10%, and then trimming under a fixed width to obtain the bamboo outer skin-retaining bamboo board finished product.

The continuous cooling is from 100° C. to 25° C., and a cooling rate is 25° C./h; and the conditions of shaping under a heavy weight and drying are as follows: the heavy weight is 1000 kg, and a drying temperature is 60° C.

### Example 3

An unfolding process of a bamboo outer skin-retaining bamboo strip includes the following steps:
step 1: segmenting bamboo to obtain bamboo tubes, and cutting each bamboo tube into bamboo strips with an arc-shaped section; where the bamboo tube has a diameter of 120 to 150 mm, and the number of bamboo strips cut from the bamboo tube is 5;
step 2: softening the bamboo strips by pressurizing and heating, unfolding the softened bamboo strips at equal arc and fixed thickness, and then shaving bamboo inner skin off, where the conditions of softening by pressurizing and heating are as follows: a pressure is 1.3 MPa, a temperature is 160° C., and time is 7 min; the unfolding process at equal arc and fixed thickness is as follows: the softened bamboo strip is pressed into an equal arc shape using an arc roller, and then processed in equal thickness with an arc cutter;
step 3: performing double-sided protection and gradual flattening on the bamboo strip treated in step 2 under a condition of heat preservation at 80° C. until the bamboo strip is completely flattened, to obtain a bamboo board, where the double-side protection and gradual flattening refers to gradually flatten through a plurality of pressing devices, each pressing device includes an upper pressing plate and a lower pressing plate between which a gap is formed, and radians of the gaps of the plurality of pressing devices are sequentially reduced; and
step 4: continuously cooling the bamboo board, shaping the bamboo board under a heavy weight and then drying until the moisture content is 6 to 10%, and then trimming under a fixed width to obtain the bamboo outer skin-retaining bamboo board finished product.

The continuous cooling is from 100° C. to 25° C., and a cooling rate is 25° C./h; and the conditions of shaping under a heavy weight and drying are as follows: the heavy weight is 1100 kg, and a drying temperature is 30° C.

### Example 4

Example 4 differs from Example 1 merely in that the cooling rate in step 4 is 30° C./h.

### Example 5

Example 5 differs from Example 1 merely in that the cooling rate in step 4 is 10° C./h.

### Comparative Example 1

Comparative example 1 differs from Example 1 merely in that the softening operation in step 2 of Comparative example 1 is different. The bamboo strips in Comparative example 1 are softened by heating, where a heating temperature is 180° C. and the heating time is 30 min.

### Comparative Example 2

Comparative example 2 differs from Example 1 merely in that: in step 3 of Comparative example 2, no heat preservation is performed, that is, double-sided protection and gradual flattening are performed under normal temperature (about 25° C.) and atmospheric pressure conditions until the bamboo strip is completely flattened, and shaping under a heavy weight and drying are performed in step 4 without cooling.

### Comparative Example 3

Comparative example 3 differs from Example 1 merely in that: unfolding at equal arc and fixed thickness and shaving of bamboo inner skin are not performed in Comparative example 3, and double-side protection and gradual unfolding are performed directly under the condition of heat preservation at 100° C. after softening by pressurizing and heating.

### Comparative Example 4

Comparative example 4 differs from Example 1 merely in that: a cooling temperature in the environment of step 4 in Comparative example 4 is maintained at 25° C. (i.e., directly cooled at 25° C.) rather than gradually cooled from 100° C. to 25° C.

Statistics are made on the number of bamboo boards with rebound and cracking and the number of qualified finished products (marked as finished products) in the processing process, and the results of calculating a qualified rate are shown in Table 1.

TABLE 1

| | | | | Comparative | Comparative | Comparative | Comparative |
|---|---|---|---|---|---|---|---|
| | Example 1 | Example 2 | Example 3 | example 1 | example 2 | example 3 | example 4 |
| Rebound | 0 | 0 | 0 | 0 | 50 | 150 | 80 |
| (strip) | | | | | | | |
| Cracking | 0 | 0 | 0 | 90 | 30 | 150 | 80 |
| (strip) | | | | | | | |
| Finished | 180 | 200 | 250 | 90 | 100 | 30 | 50 |
| product | | | | | | | |
| (strip) | | | | | | | |
| In total | 180 | 200 | 250 | 180 | 180 | 330 | 210 |
| (strip) | | | | | | | |
| Qualified | 100% | 100% | 100% | 50% | 56% | 9% | 24% |
| rate (%) | | | | | | | |

The bamboo boards of Examples 1 to 3 are randomly selected for performance testing with bamboo boards without bamboo outer skin of the same thickness, and the results are shown in Table 2.

TABLE 2

| | | | | Bamboo | Bamboo | Bamboo |
|---|---|---|---|---|---|---|
| | | | | board 1 | board 2 | board 3 |
| | | | | without | without | without |
| | | | | bamboo | bamboo | bamboo |
| | Example 1 | Example 2 | Example 3 | outer skin | outer skin | outer skin |
| Thickness | 4.5 | 7.5 | 9.5 | 4.5 | 7.5 | 9.5 |
| (mm) | | | | | | |
| Length | 1050 | 1050 | 1050 | 1050 | 1050 | 1050 |
| (cm) | | | | | | |
| Tensile | 290 | 280 | 275 | 180 | 155 | 140 |
| strength | | | | | | |
| (MPa) | | | | | | |
| Surface | 1.1 | 1.05 | 1 | 0.7 | 0.65 | 0.62 |
| density | | | | | | |
| kg/cm² | | | | | | |

### Example 6

A bamboo outer skin-retaining bamboo veneer, which is prepared by taking bamboo outer skin having a thickness of 1 to 3 mm from an outer surface of a bamboo wall to the inside, has a density of 0.9 to 1.1 g/cm³, a tensile strength of 296.72 to 311.56 MPa, a flexural strength of 143.14 to 149.65 MPa, a parallel-to-grain tensile strength of 177.76 to 185.84 MPa, a parallel-to-grain compressive strength of 77.70 to 81.22 MPa, a flexural elastic modulus of 10.12 to 11.67 GPa, a fiber content of 56.10 to 60.65%, and a moisture content of 8 to 10%.

A preparation process of the bamboo outer skin-retaining bamboo veneer includes the following steps:
step 1: segmenting bamboo (5-year-old Phyllostachys pubescens or moso bamboo) to obtain bamboo tubes, and cutting each bamboo tube into bamboo strips with an arc-shaped section, where the bamboo tube has a diameter of 60 to 150 mm, and the number of bamboo strips cut from the bamboo tube is 3 to 6;
step 2: softening the bamboo strips by pressurizing and heating, unfolding the softened bamboo strips at equal arc and fixed thickness, and then shaving bamboo inner skin off, where the conditions of softening by pressurizing and heating are as follows: a pressure is 1.2 MPa, a temperature is 200° C., and time is 3 min; the unfolding process at equal arc and fixed thickness is as follows: the softened bamboo strip is pressed into an equal arc shape using an arc roller, and then processed in equal thickness with an arc cutter;
step 3: performing double-sided protection and gradual flattening on the bamboo strip treated in step 2 under a condition of heat preservation at 100° C. until the bamboo strip is completely flattened, to obtain a bamboo board, where the double-side protection and gradual flattening refers to gradually flatten through a plurality of pressing devices, each pressing device includes an upper pressing plate and a lower pressing plate between which a gap is formed, and radians of the gaps of the plurality of pressing devices are sequentially reduced; and
step 4: continuously cooling (from 100° C. to 25° C.) the bamboo board, shaping the bamboo board under a heavy weight (the heavy weight is 1200 kg and a drying temperature 40° C.) and then drying until the moisture content is 8 to 10%, and then trimming and shaving under a fixed width to obtain the bamboo outer skin-retaining bamboo veneer with a thickness of 1 to 3 mm.

The above method can be used to prepare the bamboo outer skin-retaining bamboo veneer having a smooth surface and no cracking. Mechanical properties of bamboo outer skin-retaining bamboo veneers prepared by using different parts of the same bamboo are different, but they are all within the range of Example 1.

Three bamboo outer skin-retaining bamboo veneers obtained in Example 6 are randomly selected for performance testing, and the results are shown in Table 3.

TABLE 3

| | Bamboo outer skin- | Bamboo outer skin- | Bamboo outer skin- |
|---|---|---|---|
| | retaining bamboo | retaining bamboo | retaining bamboo |
| | veneer 1 | veneer 2 | veneer 3 |
| Raw material | 5-year-old | 5-year-old | 5-year-old |
| | phyllostachys | phyllostachys | phyllostachys |
| | pubescens | pubescens | pubescens |
| Thickness (mm) | 1 | 2 | 3 |
| Density (g/cm³) | 1.1 | 1.07 | 0.98 |
| Tensile strength | 309.47 | 305.15 | 298.67 |
| (MPa) | | | |
| Flexural strength | 149.33 | 147.55 | 144.09 |
| (MPa) | | | |
| Parallel-to-grain | 185.09 | 183.68 | 179.12 |
| tensile strength | | | |
| (MPa) | | | |
| Parallel-to-grain | 80.38 | 79.47 | 78.18 |
| compressive strength | | | |
| (MPa) | | | |
| Flexural elastic | 11.23 | 10.98 | 10.29 |
| modulus (GPa) | | | |
| Fiber content (%) | 60.58 | 58.25 | 57.66 |
| Water content (%) | 8 | 8 | 8 |

### Example 7

A bamboo board having a thickness of 10 mm is successively prepared by gluing a bamboo outer skin-retaining bamboo veneer, a first bamboo board and a second bamboo board from top to bottom, where the first bamboo board and the second bamboo board are commercially available bamboo veneers which are obtained by technologies for removing bamboo outer skin and bamboo inner skin.

In summary, according to the unfolding process of the bamboo outer skin-retaining bamboo veneer provided by the present invention, the bamboo outer skin-retaining bamboo strip can be unfolded under the promise of not opening oblique slots, nail holes, shaving bamboo outer skin and treating bamboo joints, and there will be no cracking and rebound problems in the unfolding process, so the obtained bamboo outer skin-retaining bamboo veneer is smooth and flat. The obtained bamboo outer skin-retaining bamboo veneer has the characteristics of high strength, and can be applied to the field that the existing bamboo boards cannot be used due to insufficient strength and hardness. The preparation process further broadens the application scope and field of bamboo.

According to the unfolding process of the bamboo outer skin-retaining bamboo veneer provided by the present invention, compared with traditional softening by heating, softening by pressurizing and heating in the unfolding process reflects the increase in vapor pressure and temperature increase, which can significantly shorten the softening time, improve the efficiency, and promote a softening effect at the same time, so as to avoid the problem of cracking in the subsequent unfolding process. The unfolding treatment at equal arc length and fixed length ensures the uniformity of the bamboo strips in thickness, provides a basis for the subsequent double-side protection and gradual flattening and avoids the problem of uneven stress caused by uneven thickness. The double-side protection and gradual flattening performed under the condition of heat preservation at 80 to 100° C. can effectively avoid the problems of rebound and cracking. Due to the large stress of the bamboo outer skin-retaining bamboo board, continuous cooling can avoid cracking caused by sudden cooling, and the cooled bamboo outer skin-retaining bamboo board is dried under the condition of heavy weight of 1000 to 1200 kg, which ensures the uniformity of the moisture content at different positions of the bamboo outer skin-retaining bamboo board, so that the dried flattened board has no bending, no deformation, and no rebound.

The preparation process of the bamboo outer skin-retaining bamboo veneer provided by the present invention has low requirements for equipment, and is suitable for popularization and application in enterprises of different scales due to no need to deliberately add new equipment to cooperate with said process.

According to the bamboo outer skin-retaining bamboo veneer provided by the present invention, the bamboo outer skin part is prepared into the bamboo outer skin-retaining bamboo veneer, such that the bamboo outer skin can be effectively used to avoid a large amount of wastes of raw materials caused by removal of bamboo outer skin. In addition, the prepared bamboo outer skin-retaining bamboo veneer has high hardness and good tensile and compressive properties. Due to the retention of the bamboo outer skin part, the finished product is dark green, which can provide natural green bamboo texture products that are currently in short supply on the market. The bamboo outer skin bamboo veneer can be used alone, or can be spliced with other bamboo boards, or can used as flooring, wall panels or decorative panels, or can also be directly or indirectly made into other bamboo products, such as bamboo hangers, bamboo chairs, bamboo tables, bamboo cabinets, etc.

The above are only the examples of the present invention, and are not intended to limit the patent scope of the present invention. Any equivalent replacements made by using the contents of the description of the present invention, or directly or indirectly applied in other related technical fields, are similarly included in the scope of patent protection of the present invention.

What is claimed is:

1. A preparation process of a bamboo outer skin-retaining bamboo veneer, comprising the following steps:
step 1: segmenting bamboo to obtain bamboo tubes, and cutting each bamboo tube into bamboo strips with an arc-shaped section;
step 2: softening the bamboo strips by pressurizing and heating, unfolding the softened bamboo strips at equal arc and fixed thickness, and then shaving bamboo inner skin off;
step 3: performing double-sided protection and gradual flattening on the bamboo strip treated in step 2 under a condition of heat preservation until the bamboo strip is completely flattened, to obtain a bamboo board; and
step 4: continuously cooling the bamboo board, shaping the bamboo board under a heavy weight and then drying until the moisture content is 6 to 10%, and then trimming under a fixed width to obtain the bamboo outer skin-retaining bamboo veneer.

2. The preparation process of the bamboo outer skin-retaining bamboo veneer according to claim 1, wherein, in the step 1, the bamboo tube has a diameter of 60 to 150 mm, and the number of bamboo strips cut from the bamboo tube is 3 to 6.

3. The preparation process of the bamboo outer skin-retaining bamboo veneer according to claim 1, wherein the conditions of softening by heating in the step 2 are as follows: a pressure is 0.8 to 1.3 MPa, a temperature is 160 to 200° C., and time is 3 to 10 min.

4. The preparation process of the bamboo outer skin-retaining bamboo veneer according to claim 1, wherein the unfolding process at equal arc and fixed thickness in the step 2 is as follows: the softened bamboo strip is pressed into an equal arc shape using an arc roller, and then processed in equal thickness with an arc cutter.

5. The preparation process of the bamboo outer skin-retaining bamboo veneer according to claim 1, wherein the condition of heat preservation in the step 3 is 80 to 100° C.; the double-side protection and gradual flattening refers to gradually flatten through a plurality of pressing devices; and each pressing device comprises an upper pressing plate and a lower pressing plate between which a gap is formed, and radians of the gaps of the plurality of pressing devices are sequentially reduced.

6. The preparation process of the bamboo outer skin-retaining bamboo veneer according to claim 1, wherein the continuous cooling in the step 4 is from 100° C. to 25° C.

7. The preparation process of the bamboo outer skin-retaining bamboo veneer according to claim 1, wherein the conditions of shaping under a heavy weight and drying in the step 4 are as follows: the heavy weight is 1000 to 1200 kg, and a drying temperature is 30 to 60° C.

8. A bamboo outer skin-retaining bamboo veneer prepared by the preparation process of the bamboo outer skin-retaining bamboo veneer according to claim 1.

9. A bamboo outer skin-retaining bamboo veneer prepared by the preparation process of the bamboo outer skin-retaining bamboo veneer according to claim 2.

10. A bamboo outer skin-retaining bamboo veneer prepared by the preparation process of the bamboo outer skin-retaining bamboo veneer according to claim 3.

11. A bamboo outer skin-retaining bamboo veneer prepared by the preparation process of the bamboo outer skin-retaining bamboo veneer according to claim 4.

12. A bamboo outer skin-retaining bamboo veneer prepared by the preparation process of the bamboo outer skin-retaining bamboo veneer according to claim 5.

13. A bamboo outer skin-retaining bamboo veneer prepared by the preparation process of the bamboo outer skin-retaining bamboo veneer according to claim 6.

14. A bamboo outer skin-retaining bamboo veneer prepared by the preparation process of the bamboo outer skin-retaining bamboo veneer according to claim 7.

15. The bamboo outer skin-retaining bamboo veneer according to claim 8, wherein the bamboo outer skin-retaining bamboo veneer is prepared by using bamboo outer skin having a thickness of 1 to 3 mm from an outer surface of a bamboo wall to the inside as a raw material.

16. The bamboo outer skin-retaining bamboo veneer according to claim 9, wherein the bamboo outer skin-retaining bamboo veneer is prepared by using bamboo outer skin having a thickness of 1 to 3 mm from an outer surface of a bamboo wall to the inside as a raw material.

17. The bamboo outer skin-retaining bamboo veneer according to claim 10, wherein the bamboo outer skin-retaining bamboo veneer is prepared by using bamboo outer skin having a thickness of 1 to 3 mm from an outer surface of a bamboo wall to the inside as a raw material.

18. The bamboo outer skin-retaining bamboo veneer according to claim 11, wherein the bamboo outer skin-retaining bamboo veneer is prepared by using bamboo outer skin having a thickness of 1 to 3 mm from an outer surface of a bamboo wall to the inside as a raw material.

19. The bamboo outer skin-retaining bamboo veneer according to claim 12, wherein the bamboo outer skin-retaining bamboo veneer is prepared by using bamboo outer skin having a thickness of 1 to 3 mm from an outer surface of a bamboo wall to the inside as a raw material.

20. The bamboo outer skin-retaining bamboo veneer according to claim 15, wherein the bamboo outer skin-retaining bamboo veneer has a density of 0.9 to 1.1 g/cm³, a tensile strength of 296.72 to 311.56 MPa, a flexural strength of 143.14 to 149.65 MPa, a parallel-to-grain tensile strength of 177.76 to 185.84 MPa, and a parallel-to-grain compressive strength of to 77.70 to 81.22 MPa.
